(19) United States
(12) Patent Application Publication
(10) Pub. No.: US 2025/0041751 A1
(43) Pub. Date: Feb. 6, 2025

(54) SOLID BATH AGENT

(71) Applicant: BANDAI CO., LTD., Tokyo (JP)

(72) Inventor: Kana KUSHIRO, Tokyo (JP)

(21) Appl. No.: 18/792,480

(22) Filed: Aug. 1, 2024

(30) Foreign Application Priority Data
Aug. 3, 2023 (JP) 2023-127220

(51) Int. Cl. A63H 23/10; A63H 33/28

(52) U.S. Cl. CPC A63H 23/10; A63H 33/28

(57) ABSTRACT

A solid bath agent comprises a water soluble main body, a first component which is enclosed in the main body, wherein the main body is configured so that the first component is visible before dissolution thereof, and the first component is configured to be connectable to the second component which is not enclosed in the main body, after the dissolution of the main body.

### CROSS-REFERENCE TO RELATED APPLICATIONS

The disclosure of Japanese Patent Application No. 2023-127220 filed on Aug. 3, 2023 including specification, drawings and claims is incorporated herein by reference in its entirety.

### TECHNICAL FIELD

The present invention relates to a solid bath agent.

### BACKGROUND

Conventionally, for example, in a toy disclosed in Japanese Patent Application Publication No, H07-24394, whiteboards are placed on both sides of a frame, wherein one side thereof is used for free drawing and the other side thereof is used for coloring pictures which have outlines drawn in indelible lines in advance. In addition, on the coloring side, puzzle pieces made of magnetic sheets can be arranged to play, and further, the puzzle pieces can be finely divided by cutting along reference lines drawn on the back of the puzzle.

### SUMMARY

### Technical Problem

The toy disclosed in Japanese Patent Application Publication No. H07-24394 discloses a multifunctional toy for children, which has the face of the whiteboard for free drawing and the face for coloring, and which may be enjoyed as a jigsaw puzzle. If the puzzle pieces are cut, they become finer pieces forming the puzzle. However, the toy disclosed in H07-24394 lacks gimmicks and has issues regarding interesting features.

It is an object of the present invention to provide a highly enjoyable solid bath agent.

### Solution to Problem

One of the aspects of the present invention is a solid bath agent. The solid bath agent comprises a water-soluble main body and a first component included in the main body, wherein the first component included in the main body is visible before the main body is dissolved, and after the main body is dissolved, the first component is connectable to a second component which is not included in the main body.

### Advantageous Effect of Invention

According to the present invention, it is possible to provide a solid bath agent whose usability is improved.

### BRIEF DESCRIPTION OF DRAWINGS

FIG. 1 is a perspective view of a solid bath agent according to an embodiment of the present invention, showing one form of the solid bath agent;

FIG. 2 is a cross-sectional view thereof taken along line 2-2 of the solid bath agent shown in FIG. 1;

FIG. 3 is an explanatory diagram showing a state where a main body of the solid bath agent is placed in hot water;

FIG. 4 is a schematic diagram of a first component showing a state where the first component floats;

FIG. 5 is a perspective view of the first component;

FIG. 6 is a perspective view of a second component;

FIG. 7 is an exploded perspective view of the second component;

FIG. 8 is a perspective view of the first component and the second component in a state where the first component and the second component are assembled;

FIG. 9 is a cross-sectional view thereof taken along line 9-9 shown in FIG. 8; and

FIG. 10 is a perspective view of the solid bath agent showing an example of the provision form thereof.

### DETAILED DESCRIPTION

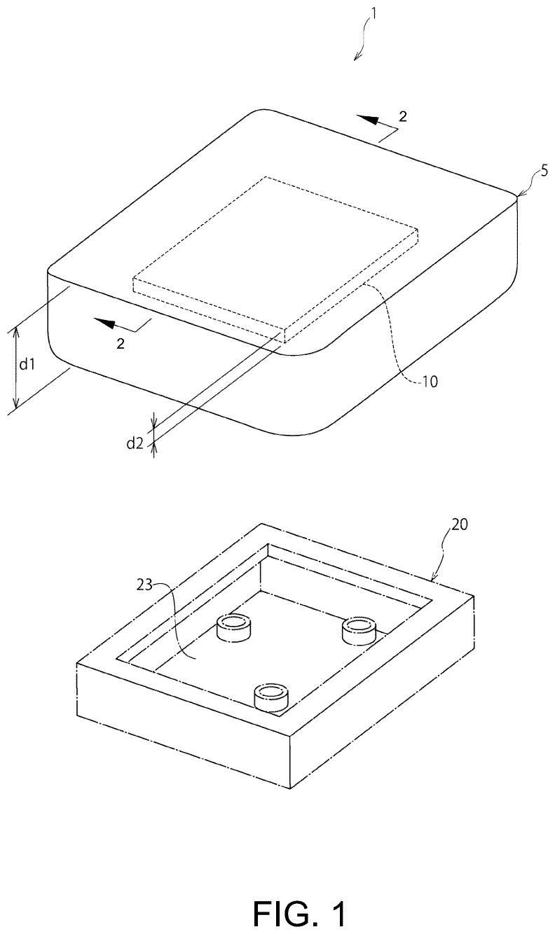

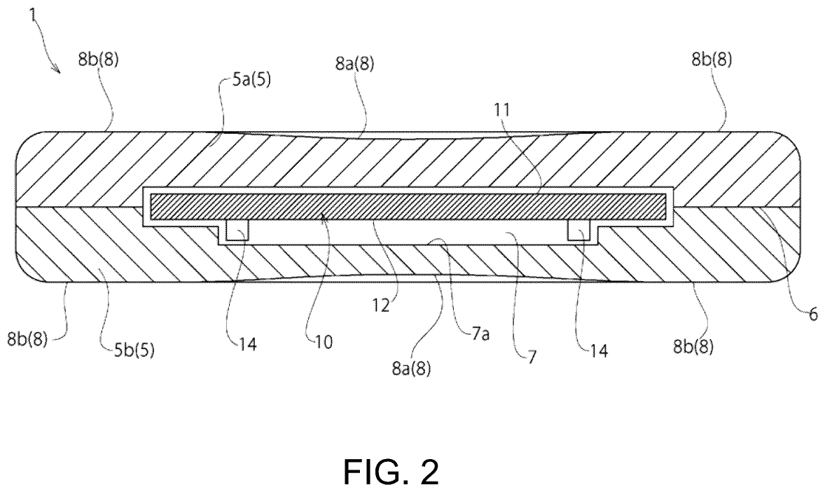

A solid bath agent according to an embodiment of the present invention will be described with reference to the figures. FIG. 1 is a perspective view of the solid bath agent 1, and FIG. 2 is a cross-sectional view thereof taken along line 2-2 of the solid bath agent 1 shown in FIG. 1.

The solid bath agent 1 comprises a main body 5 having a first component 10 inside the main body, and a frame-shaped second component, as will be described later. As shown in FIG. 1, the main body 5 is configured in a rectangular, flat shape, and is colored, for example, light blue. The first component 10 is not visible from the outside of the main body and is a plate-like member provided inside the main body 5 as shown in FIG. 2. The main body 5 is made of a water-soluble material which dissolves in water or hot water, causing its color to dissolve into the water or hot water, which surrounds the material.

The main body 5 is, for example, configured by bonding upper and lower members 5a, 5b together at a line 6 during manufacturing. For example, the main body 5 is formed by connecting the upper and lower members 5a and 5b to each other in a state where the first component 10 is housed in a recessed space 7 formed by the upper and lower members 5a and 5b. Therefore, the first component 10 is housed so that it cannot be seen from the outside. Thereby, a toy can be configured so that this first component 10 is connected to the second component 20, which is described later. That is, the first component 10, which cannot be seen before the dissolution of the main body 5, appears due to the dissolution of the main body 5, and the first component 10 can be connected to the second component 20.

The main body 5 does not have any particular size limitation, but for example, it can be configured to have a thickness (d1) ranging from 1 cm to 3 cm. In addition, since the first component 10 is housed inside the main body 5, the first component 10 has a thin plate shape with a thickness (d2), which is less than the aforementioned size of the main body 5. Also, the main body 5 has concave-convex portions 8 (concave portions 8a and a convex portions 8b) formed on a front side thereof (an upper side in the figure) and a back side thereof (a lower side in the figure). For example, the concave portion 8a is formed at a central part on each side, and the convex portion 8b is formed so as to slightly protrude at an outer edge of the concave portion 8a on each side.

The concave-convex portion 8 may be configured with many small concaves and convexes rather than the illustrated concave-convex portions. Or, the outer surface of the main body 5 may have fine concaves and convexes such as a rough surface. By having such concave-convex portions 8, the main body 5 not only becomes easier to be held by a hand but also has an increased surface area for easier dissolution.

As shown in FIG. 2, the main body 5 has a predetermined space 7 around the first component 10 before it is dissolved, and the first component 10 is housed in this space 7. Thus, the space 7 of the main body 5 is formed so as to be large enough to create a gap between the first component 10 and the main body 5. This allows for variations in the size of the first component 10, so that the first component 10 can be certainly housed therein, and it is possible to prevent the first component 10 from closely adhering to the main body 5.

Additionally, as will be described later, two or more protrusions 14 are formed on the second face 12, which is a back side face of the first component 10. These protrusions 14 are used as connecting means when connecting to a second component 20, as will be described later, but they serve another function when housed within the main body 5. For example, on the lower side of the space 7, a recessed part 7a is formed to enlarge the space 7, and the protrusions 14 are positioned to fit into this recessed part 7a. This allows the protrusions 14 to function as positioning means when the first component 10 is set in the main body 5.

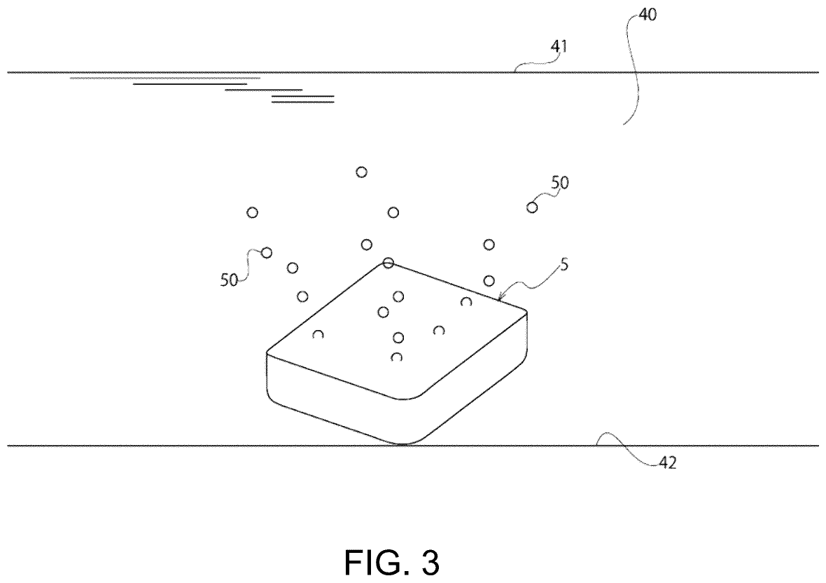

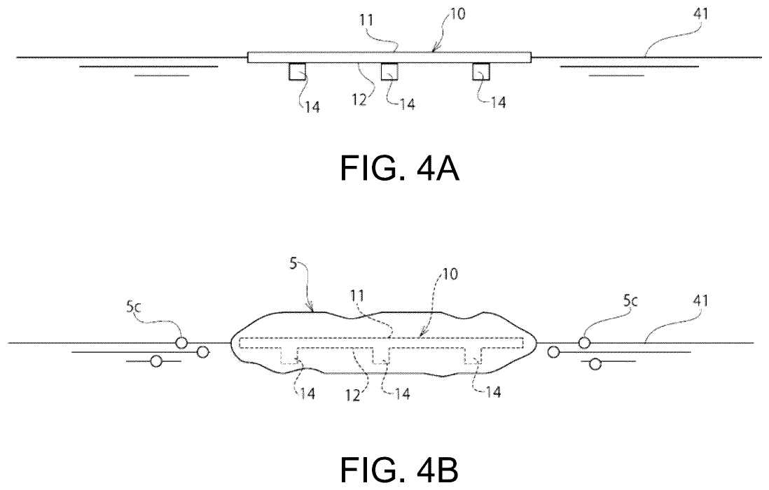

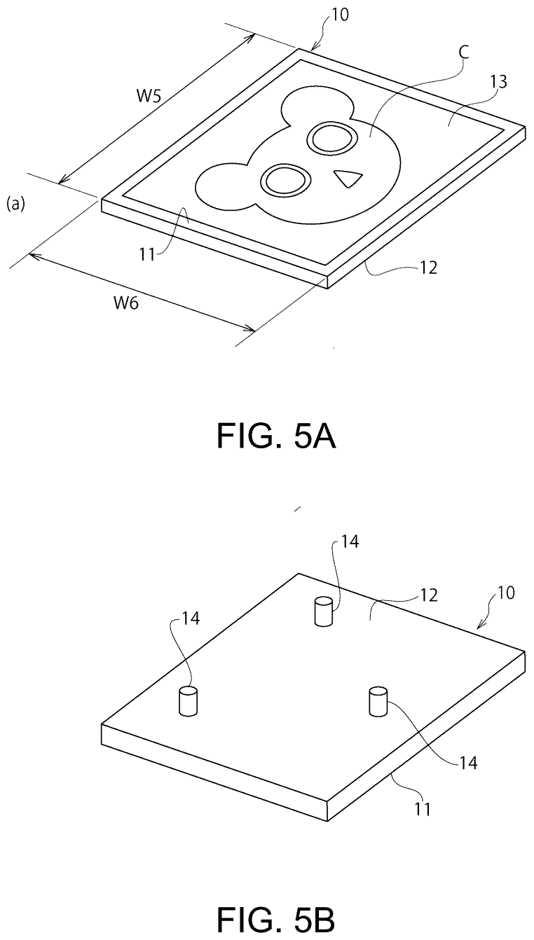

FIG. 3 is an explanatory diagram showing a state where the main body 5 is placed in the hot water 40 of a bathtub. FIGS. 4A and 4B are a schematic diagram showing states where the first component 10 floats. Additionally, FIG. 5 is a perspective view of the first component 10.

When the main body 5 is placed in the hot water 40 of the bathtub, as shown in FIG. 3, the main body 5 sinks below the water surface 41 of the hot water 40 so as to be in contact with a bottom 42 of the bathtub. When the main body 5 contains a foaming material, the water-soluble main body 5 gradually dissolves while releasing bubbles 50, and a specific color dissolves into the water in the bathtub.

In this manner, as the main body 5 dissolves, the volume of the main body 5 decreases and eventually it completely dissolves. As a result, as shown in FIGS. 4A and 4B, the first component 10 housed within the main body 5 floats to the water surface 41. This is because the main body 5 is configured with a specific gravity of 1 or more, while the first component 10 is configured with a specific gravity of 1 or less. Thus, the main body 5 is manufactured, considering the total weight of both components. As a result, it is possible to create the state where the main body 5 sinks in water and the state where the first component 10 floats to the water surface 41.

The first component 10 floating on the water surface 41, may be in a state where the main body 5 has almost completely dissolved as shown in FIG. 4A, or a state where the first component 10 has not yet fully dissolved as shown in FIG. 4B. Either case can be set by appropriately setting the timing of the floating according to the weight balance between the main body 5 and the first component 10, as mentioned above.

Additionally, as shown in FIGS. 5A and 5B, the first component 10 is a rectangular plate-like member in a plan view thereof. As shown in FIG. 5A, a pattern C, such as a character image, is drawn on a first face 11, which is a front side thereof. Two or more kinds of such patterns C are prepared. For example, the pattern C is drawn on a sticker member 13, and this sticker member 13 is attached to the first face 11. On a second face, which is the back side of the first component 10, as shown in FIG. 5B, for example, three column-shaped protrusions 14 are provided. With the first component 10 configured in this manner, as shown in FIG. 4A, when it floats on the water surface 41, the first face 11 is likely to face upwards, allowing the pattern C to be visible when it appears on the water surface 41.

Described below is case where the main body 5 around the first component 10 partially remains but still floating on the water surface, as shown in FIG. 4B. In this case, on the surface of the hot water 41, one can enjoy watching the main body 5 melting away gradually. As the main body 5 diminishes, one can enjoy the process in which the picture pattern C gradually becomes visible. Furthermore, after the main body 5 is dissolved, if the first component 10 is left floating on the hot water surface 41 with the first side 11 facing upward (where the picture pattern C is on an upper side), the first component 10 having the picture pattern C can be used as a display on the hot water surface 41. Additionally, the first component 10 can be taken out from the hot water surface 41 and displayed elsewhere.

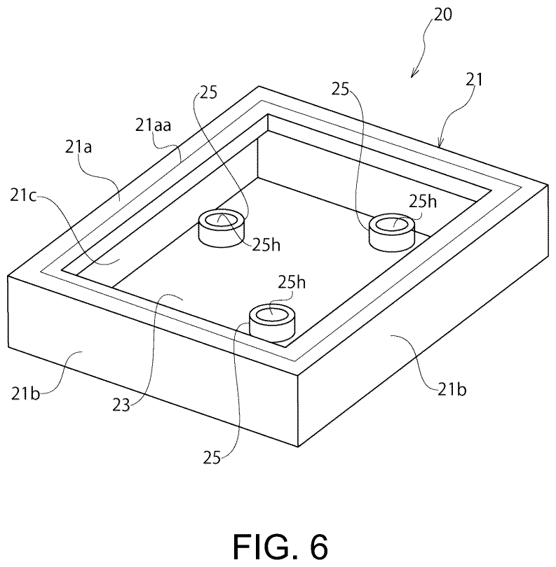

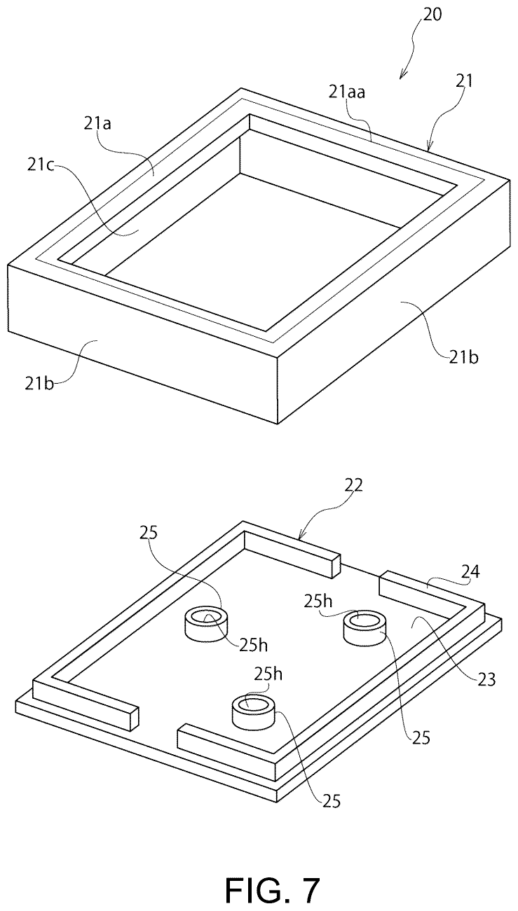

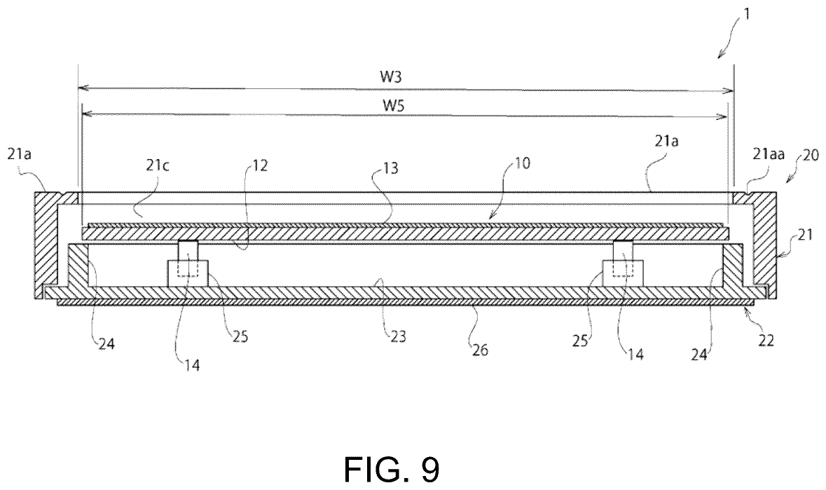

FIG. 6 is a perspective view of the second component 20. FIG. 7 is an exploded perspective view of the second component 20. The second component 20 has a rectangular frame structure in a plan view thereof. For example, side sections 21b and an edge section 21a which form four sides of the outer circumference on a front side are configured to have the depth and edge widths of the picture frame. Additionally, the edge section 21a has decorative ridges 21aa on its upper surface (see FIG. 9), showing an ornament-like appearance on the frame. In the recess 21c, the first component 10 can be accommodated inside the edge section 21aa. For example, three connecting bosses 25 are provided at a predetermined interval on a bottom surface 23 of this recess 21c. Each of these connecting bosses 25 has a connecting hole 25h which can engage with one of the protrusions 14 of the first component 10.

Although the second component 20 is usually provided in the assembled state as shown in FIG. 6, wherein as shown in FIG. 7, the second component 20 comprises a front member 21 forming a front side thereof and a rear member 22 forming a back side thereof. An edge protrusion 24 is formed to surround an edge portion of the rear member 22 on the front side of the bottom surface 23. The second component is assembled so that this edge protrusion 24 fits inside the side sections 21b of the front member 21.

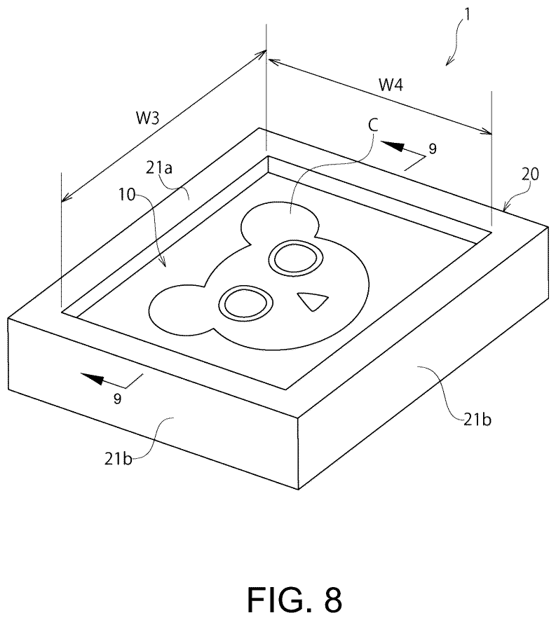

FIG. 8 shows a perspective view of the assembly of the first component 10 and the second component 20. FIG. 9 is a cross-sectional view thereof taken along a line 9-9 shown in FIG. 8. When connecting the first component 10 to the second component 20, for example, the first component 10 is inserted into the recess 21c from the front side of the second component 20. That is, the first component 10 is attached to the second component 20 by fitting the protrusions 14 of the first component 10 into the connecting bosses 25 provided inside the recess 21c. In this case, the horizontal dimension W5 and the vertical dimension W6 (see FIG. 5) of the first component 10 are smaller than the horizontal dimension W3 and the vertical dimension W4 of the recess 21c in the second component 20.

When the first component 10 is set in the second component 20, the second component 20 forms a frame which surrounds the perimeter of the picture pattern C like a picture frame, in a state where the edge section 21a protrudes more towards the front side than the first component 10. Moreover, the first component 10 is withdrawn toward the inside from the edge section 21a and the second side 12 and the bottom surface 23 are spaced apart by a predetermined distance. Here, the insertion depth (connection depth) of the protrusions 14 of the first component 10 with respect to the connecting bosses 25 can be adjusted.

Additionally, since the side sections 21b have a certain thickness, when the unit is placed upright on a surface, it can be displayed without rolling over. Furthermore, in the second component 20, as shown in FIG. 9, a magnet 26 is provided on the back side (the lower side in the figure) of the bottom surface 23. This magnet 26 is a plate-shaped magnet with a size approximating the area of the bottom surface 23. The magnet 26 is not limited to such a relatively large plate-like configuration. For example, two or more magnets may be provided on the bottom surface 23 side (inside the rear member 22 as shown in the figure).

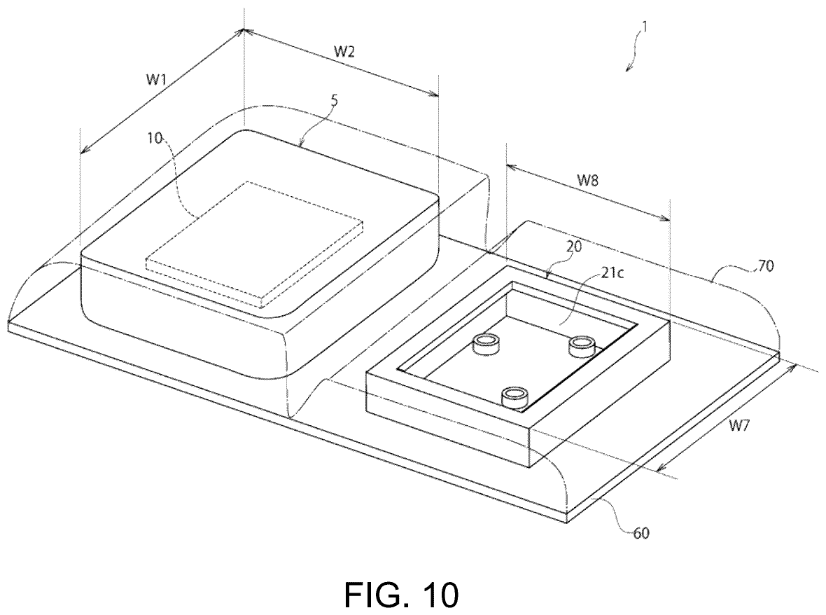

FIG. 10 is a perspective view of an example of the solid bath agent 1 in a form in which the solid bath agent 1 is supplied. The solid bath agent 1 can be provided and sold in the form shown in FIG. 10, where the main body 5 and the second component 20 are fixed near each other on a mounting sheet 60 covered by a transparent wrapping member 70 or the like. In this case, as shown in the figure, the longitudinal and lateral dimensions (W1, W2) of the main body 5 are larger than the longitudinal and lateral dimensions (W7, W8) of the second component 20. The longitudinal and lateral dimensions (W7, W8) of the second component 20 are larger than the longitudinal and lateral dimensions (W5, W6) of the first component 10.

As described above, since the solid bath agent 1 according to the present embodiment is provided in such a way that the first component 10 is not visible, it is possible to create an expectation about what is contained within the main body 5. After the main body 5 has dissolved, since the first component 10 can be connected to the second component 20, a unit in which the first component 10 and the second component 20 are connected to each other can be enjoyed as a toy.

Additionally, in the solid bath agent 1 according to the present embodiment, since the accommodation space of the main body 5 covers the space around the first component 10, this allows for variations in the size of the first component 10, so that the first component 10 can be certainly housed. Since it is possible to prevent the first component 10 from closely adhering to the main body 5, a change in quality or discoloration can be avoided.

Furthermore, in the solid bath agent 1 according to the embodiments, when the main body 5 is composed of two parts combined vertically, the first component 10 can be easily positioned in the accommodating part of one of parts of the main body 5, using the mounting protrusions 14, thereby facilitating the assembly of the first component 10.

Also, in the solid bath agent 1 according to the embodiments, the first component 10 can float up after initially sinking in the water. Since the main body floats up when it is dissolving, it is possible to watch the main body 5 dissolving (process).

In the solid bath agent 1 according to the embodiments, since the first component 10 can be connected to the recess 21c of the second component 20, the first component 10 can be connected thereto so that the first component surrounds the second component 20.

Moreover, in the solid bath agent 1 according to the embodiments, since the back side of the first component 10 and the bottom surface 23 of the second component 20 can be connected to each other with a gap between them, a sense of three-dimensionality can be created by this configuration. Furthermore, in the solid bath agent according to the embodiments, since the first component 10 has a thickness less than the thickness of the main body 5, the first component 10 can be securely accommodated within the main body 5. A toy like a picture in frame, in which a picture pattern C is depicted, can be provided.

Additionally, in the solid bath agent 1 according to the embodiments, since the concave-convex portions 8 are formed on the surface of the main body 5, it can be easily gripped. When it is used as a bath agent, a visually pleasing effect in the hot water can be created by the coloring of the main body 5.

As described above, while the embodiments of the present invention has been explained above, the present invention can be appropriately modified within the scope of its technical ideas. For example, in the above embodiment, the magnet 26 is provided in the second component 20, but it is not limited to this configuration and can be provided in the first component 10 as well.

As described above, the following aspects are disclosed in this specification:
(1) A solid bath agent comprises a water soluble main body, a first component which is enclosed in the main body, wherein the main body is configured so that the first component is visible before dissolution thereof, and the first component is configured to be connectable to the second component which is not enclosed in the main body, after the dissolution of the main body.
(2) In the solid bath agent according to (1), the first component is not connectable to the second component before the dissolution of the main body.
(3) In the solid bath agent according to (1) or (2), the main body, the first component and the second component are configured so as not to be rollable.
(4) In the solid bath agent according to any one of (1) to (3), the main body covers the first component so that a certain space around the first component exists, before the dissolution.
(5) In the solid bath agent according to any one of (1) to (4), the first component sinks in water before the dissolution of the main body, and floats up during
(6) In the solid bath agent according to any one of (1) to (6), the first component is configured to be displayed along after the dissolution of the main body.
(7) In the solid bath agent according to any one of (1) to (6), the first component is configured so as to be displayed after the dissolution of the main body in a state where the first component and the second component are connected to each other.
(8) In the solid bath agent according to any one of (1) to (7), the second component include a concave portion, and the first component is configured so as to be connectable to the concave portion.
(9) In the solid bath agent according to any one of (1) to (8), the first component is configured as a plate member having a first face and a second face, and the second component functions as a frame surrounding a perimeter of the first component.
(10) In the solid bath agent according to any one of (1) to (9), a convex portion configured to be connectable to a part of the convex portion is provided on the second face of the first component, and the convex portion functions as a positioning member in the main body.
(11) In the solid bath agent according to either (9) or (10), the first component is connectable thereto in a state that the second face and a bottom face of the concave portion are apart from each other.
(12) In the solid bath agent according to any one of (9) to (11), an image including a character is depicted on the first face.
(13) In the solid bath agent according to any one of (1) to (12), the main body has a thickness in a range of 1 to 3 cm, and the first component has a thickness less than the thickness of the main body.
(14) In the solid bath agent according to any one of (1) to (13), the main body has irregularities on a surface thereof, and is colored.
(15) In the solid bath agent according to any one of (1) to (14), the main body and the first component are flat-shaped.
(16) In the solid bath agent according to any one of (1) to (15), the main body has dimensions larger than those of the second component, and the second component has dimensions larger than those of the first component.
(17) In the solid bath agent according to any one of (1) to (16), the second component is provided adjacent to the main body in a supply form.
(18) In the solid bath agent according to any one of (1) to (17), at least one of the first component and second component includes a magnet.

1. A solid bath agent comprising:
a water soluble main body;
a first component which is enclosed in the main body,
wherein the main body is configured so that the first component is visible before dissolution thereof, and the first component is configured to be connectable to the second component which is not enclosed in the main body, after the dissolution of the main body.

2. The solid bath agent according to claim 1, wherein the first component is not connectable to the second component before the dissolution of the main body.

3. In the solid bath agent according to claim 2, wherein the main body, the first component and the second component are configured so as not to be rollable.

4. The solid bath agent according to claim 3, wherein the main body covers the first component so that a certain space around the first component exists, before the dissolution.

5. The solid bath agent according to claim 1, wherein the first component sinks in water before the dissolution of the main body, and floats up during or after the dissolution of the main body.

6. The solid bath agent according to claim 1, wherein the first component alone is configured to be displayable after the dissolution of the main body.

7. The solid bath agent according to claim 1, wherein the first component is configured so as to be displayable after the dissolution of the main body in a state where the first component and the second component are connected to each other.

8. The solid bath agent according to claim 7, wherein the second component include a concave portion, and the first component is configured so as to be connectable to the concave portion.

9. The solid bath agent according to claim 1, wherein the first component is configured as a plate member having a first face and a second face, and the second component functions as a frame surrounding a perimeter of the first component.

10. The solid bath agent according to claim 8, wherein a convex portion configured to be connectable to a part of the concave portion is provided on the second face of the first component, and the convex portion functions as a positioning member in the main body.

11. The solid bath agent according to claim 10, wherein the first component is connectable thereto in a state where the second face and a bottom face of the concave portion are apart from each other.

12. The solid bath agent according to claim 9, wherein an image including a character is depicted on the first face.

13. The solid bath agent according to claim 1, wherein the main body has a thickness ranging from 1 to 3 cm, and the first component has a thickness less than the thickness of the main body.

14. The solid bath agent according to claim 1, wherein the main body has a concave-convex portion on a surface thereof, and is colored.

15. The solid bath agent according to claim 1, wherein the main body and the first component are flat-shaped.

16. The solid bath agent according to claim 1, wherein the main body has longitudinal and lateral dimensions larger than those of the second component, and the second component has longitudinal and lateral dimensions larger than those of the first component.

17. The solid bath agent according to claim 1, wherein the second component is provided adjacent to the main body in a supply form.

18. The solid bath agent according to claim 1, wherein at least one of the first component and the second component includes a magnet.
